(19) United States
(12) Patent Application Publication
(10) Pub. No.: US 2025/0103240 A1
(43) Pub. Date: Mar. 27, 2025

(54) CONTROL DEVICE, DETECTION METHOD, AND NON-TRANSITORY COMPUTER-READABLE MEDIUM STORING DETECTION PROGRAM

(71) Applicant: LAPIS Technology Co., Ltd., Yokohama-shi (JP)

(72) Inventor: Ryu SOGA, Yokohama-shi (JP)

(21) Appl. No.: 18/897,157

(22) Filed: Sep. 26, 2024

(30) Foreign Application Priority Data
Sep. 26, 2023 (JP) 2023-163987

(51) Int. Cl. G06F 3/06

(52) U.S. Cl. CPC G06F 3/0655; G06F 3/0619; G06F 3/0673

(57) ABSTRACT

A control device including: a processor, the processor being configured to: acquire write data; store the write data as first write data in a first region of a non-volatile storage section with an error detection code attached; store the first write data as second write data in a second region of a non-rewritable storage section; and store the second write data as third write data in a third region of the non-volatile storage section.

### CROSS-REFERENCE TO RELATED APPLICATION

This application claims priority under 35 USC 119 from Japanese Patent Application No. 2023-163987, filed on Sep. 26, 2023, the disclosure of which is incorporated by reference herein.

### BACKGROUND

### Technical Field

The present disclosure relates to a control device, a detection method, and a non-transitory computer-readable medium storing a detection program.

### Related Art

Generally, as a medium for storing data not to be erased, such as logs, a non-rewritable storage section such as a One-Time-Programmable ROM (OTP) is employed to store such data. Sometimes power is unintentionally interrupted during storing of write data to such a non-rewritable storage section. When power is unintentionally interrupted during writing write data to the non-rewritable storage section, then this sometimes results in the write data being stored in an abnormal state, such as being stored in an incomplete state, being stored in a faulty state, or the like.

In order to address such situations, technology is known for checking whether or not normal write data is stored. For example, Japanese Patent Application Laid-Open (JP-A) No. H01-265343 discloses a technology including a first region for storing circuit information, and a second region for storing circuit information different to the circuit information of the first region. In this technology, circuit information is read from the first region when power is switched ON, and this circuit information is used to check whether normal circuit information is stored in the second region.

However, technology hitherto is sometimes unable to determine whether or not the stored write data is normal. For example, the technology disclosed in JP-A No. H01-265343 is unable to detect whether or not the circuit information stored in the second region is normal in a case in which the stored circuit information has become abnormal due to a power interruption occurring during storing the circuit information in the first region. This accordingly leads to the issue that abnormal write data is not able to be repaired, when the detection of whether normal or not has not been performed appropriately. Accordingly, there is a desire for technology capable of appropriately detecting whether or not an abnormality has arisen in stored write data, due to power being interrupted during writing of write data.

### SUMMARY

A first aspect of the present disclosure is a control device including: a processor, the processor being configured to: acquire write data; store the write data as first write data in a first region of a non-volatile storage section with an error detection code attached; store the first write data as second write data in a second region of a non-rewritable storage section; and store the second write data as third write data in a third region of the non-volatile storage section.

A second aspect of the preset disclosure is a detection method for detecting whether or not power was interrupted during processing by a processor of a control device during storing of write data in a non-rewritable storage section, the detection method including: acquiring write data; storing the write data as first write data in a first region of a non-volatile storage section with an error detection code attached; storing the first write data as second write data in a second region of a non-rewritable storage section; storing the second write data as third write data in a third region of the non-volatile storage section; and determining whether or not the power was interrupted during writing, based on a comparison result from comparing the first write data, the second write data, and the third write data.

A third aspect of the present disclosure is a non-transitory computer-readable medium storing a detection program executable by a processor of a control device to perform processing to detect whether or not power was interrupted during processing to store write data in a non-rewritable storage section, the processing including: acquiring write data; storing the write data as first write data in a first region of a non-volatile storage section with an error detection code attached; storing the first write data as second write data in a second region of a non-rewritable storage section; storing the second write data as third write data in a third region of the non-volatile storage section; and determining whether or not power was interrupted during writing, based on a comparison result from comparing the first write data, the second write data, and the third write data.

### BRIEF DESCRIPTION OF THE DRAWINGS

Exemplary embodiments will be described in detail based on the following figures, wherein:

FIG. 1 is a block diagram illustrating a configuration of a memory system of an exemplary embodiment;

FIG. 2 is a flowchart illustrating a flow of write processing;

FIG. 3 is a flowchart illustrating a flow of detection processing;

FIG. 4 is a flowchart illustrating a flow of normal determination processing;

FIG. 5 is a flowchart illustrating a flow of first write determination processing;

FIG. 6 is a flowchart illustrating a flow of second write determination processing; and

FIG. 7 is a flowchart illustrating a flow of third write determination processing.

### DETAILED DESCRIPTION

The present disclosure provides a control device, a detection method, and a computer-readable medium storing a detection program, that may detect whether or not power was interrupted during writing of write data to a non-rewritable storage section, and that may enable to repair the stored write data.

Detailed description follows regarding an exemplary embodiment of the present disclosure, with reference to the drawings. Note that the following exemplary embodiment is not a limitation to technology disclosed herein.

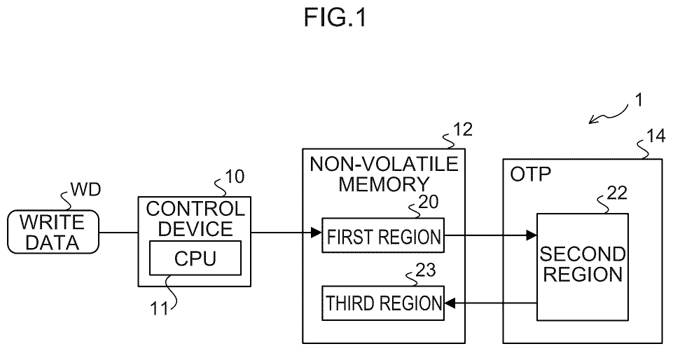

First description follows regarding an example of a configuration of a memory system of the present exemplary embodiment, with reference to FIG. 1. FIG. 1 is a block diagram illustrating an example of a configuration of a memory system 1 of the present exemplary embodiment. The memory system 1 of the present exemplary embodiment includes a control device 10, a non-volatile memory 12, and a One-Time-Programmable (OTP) ROM 14. Note that the non-volatile memory 12 of the present exemplary embodiment is an example of a non-volatile storage section of the present disclosure, and the OTP 14 of the present exemplary embodiment illustrates an example of a non-rewritable storage section of the present disclosure.

In the memory system 1, write data WD is stored on the OTP 14 under control from the control device 10. The write data stored on the OTP 14 is for output externally to the memory system 1, and is for use by a device external to the memory system 1.

The control device 10 includes a central processing unit (CPU) 11, and the CPU 11 performs processing to write the write data WD to the OTP 14. Note that the CPU 11 of the present exemplary embodiment illustrates an example of a processor of the present disclosure.

The non-volatile memory 12 and the OTP 14 are provided on the same semiconductor device (omitted in the drawings). The non-volatile memory 12 includes a first region 20 and a third region 23 as regions for writing data. Write data WD is written to the first region 20 under control from the CPU 11 of the control device 10. In the present exemplary embodiment, write data WD is stored on the first region 20 with a check sum such as Cyclic Redundancy Check (CRC) or the like attached thereto. In the present exemplary embodiment, the write data WD stored in the first region 20 is referred to as “first write data WD_1”. Note that the check sum of the present exemplary embodiment is an example of an error detection code of the present disclosure.

Moreover, second write data WD_2 read from a second region 22 of the OTP 14 is written to the third region 23 under control from the CPU 11 of the control device 10. In the present exemplary embodiment, the second write data WD_2 stored in the third region 23 is referred to as “third write data WD_3”. In the present exemplary embodiment, the second write data WD_2 is stored in the third region 23 with a check sum such as a CRC attached thereto.

Note that in the present exemplary embodiment, addresses of the first region 20 and the third region 23 are output to the control device 10. The CPU 11 references these addresses, and is thereby able to identify regions where the first write data WD_1 and the third write data WD_3 are stored.

The OTP 14 is a storage section where rewriting of written data is not able to be performed. The OTP 14 includes the second region 22. The first write data WD_1 read from the first region 20 of the non-volatile memory 12 is written to the second region 22 under control from the CPU 11 of the control device 10. In the present exemplary embodiment, the write data WD stored in the second region 22 is referred to as “second write data”.

Note that in the present exemplary embodiment, the address of the second region 22 is output to the control device 10. The CPU 11 is able to identify the region where the second write data WD_2 is stored by referencing this address.

Note that, in the following, the write data WD, the first write data WD_1, the second write data WD_2, and the third write data WD_3 are simply referred to as “write data” when referred to collectively without being individually distinguished.

Thus, in the memory system 1 of the present exemplary embodiment, first the write data WD is written to the first region 20 of the non-volatile memory 12 and stored as the first write data WD_1 under control from the CPU 11 of the control device 10. Next, under control of the CPU 11, the first write data WD_1 read from the first region 20 of the non-volatile memory 12 is written to the second region 22 of the OTP 14 and stored as the second write data WD_2. Furthermore, under control of the CPU 11, the second write data WD_2 read from the second region 22 of the OTP 14 is written to the third region 23 of the non-volatile memory 12 and stored as the third write data WD_3.

The write data WD, the first write data WD_1, the second write data WD_2, and the third write data WD_3 are the same data in a case in which all writing has been performed normally. However, there may be cases in which normal data is not written due to power being interrupted during writing. For example, there may be cases in which write data has not been written at all, writing is in an incomplete state, or a read value (0 or 1) differs each time read. Namely, in a case in which an abnormality has occurred, such as power being interrupted during writing, at least one out of the first write data WD_1, the second write data WD_2, or the third write data WD_3 is not normal. This means that power interruption during writing the write data to one of other of the regions can be determined by comparing the first write data WD_1, the second write data WD_2, and the third write data WD_3. Note that, cases of “not normal” and “abnormal” for the data written, in other words for the data stored, include cases in which data is different to the true data, as well as cases in which data is not present.

Specifically, in the memory system 1 of the present exemplary embodiment, cases in which a power interruption has occurred during writing are as set out below.
(1) Cases in which power was not interrupted during writing of write data in any region out of the first region 20, the second region 22, and the third region 23, namely cases in which write data has been written normally to each of the regions. In this case the first write data WD_1 and the third write data WD_3 are the same.
(2) Cases in which the power was interrupted during writing the write data WD to the first region 20 of the non-volatile memory 12 as the first write data WD_1. In this case the second write data WD_2 differs from the first write data WD_1 but is the same as the third write data WD_3, and the first write data WD_1 is not in a normal state. In this case, the control device 10 performs repair of the write data stored to each of the regions by writing the write data to the first region 20, the second region 22, and the third region 23.
(3) Cases in which power was interrupted during writing the first write data WD_1 to the second region 22 of the OTP 14 as the second write data WD_2. In this case, the second write data WD_2 differs from the first write data WD_1 but is the same as the third write data WD_3, and the first write data WD_1 is in a normal state. Or alternatively, the first write data WD_1, the second write data WD_2, and the third write data WD_3, are all different and also the first write data WD_1 is in a normal state. In this case, the control device 10 performs repair of the write data stored in the second region 22 and the third region 23 by writing the write data to the second region 22, and the third region 23.
(4) Cases in which power was interrupted during writing the second write data WD_2 to the third region 23 of the non-volatile memory 12 as the third write data WD_3. This case results in a state in which the first write data WD_1 is the same as the second write data WD_2 but is different to the third write data WD_3. In this case, the control device 10 performs repair of the write data stored in the third region 23 by writing the write data to the third region 23.

In the control device 10 of the present exemplary embodiment, the fact that a power interruption occurred during writing the write data to one of the regions is determined by comparing the first write data WD_1, the second write data WD_2, and the third write data WD_3, and repair of the write data stored is performed as required.

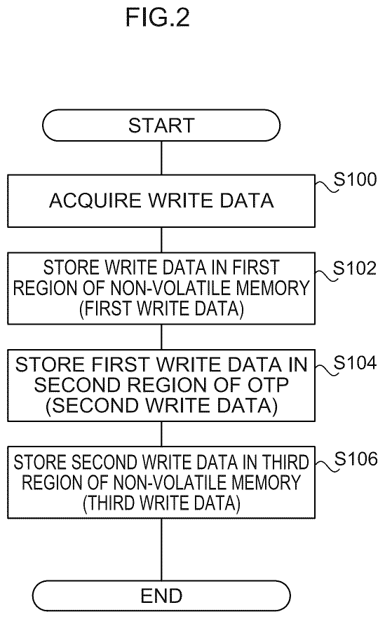

Description follows regarding operation of the control device 10 of the present exemplary embodiment, with reference to the drawings. First, description follows regarding write processing by the CPU 11 of the control device 10 to write the write data WD, with reference to FIG. 2. FIG. 2 is a flowchart illustrating an example of a flow of write processing executed in the CPU 11. In the present exemplary embodiment, the write processing illustrated in FIG. 2 is executed by the CPU 11 executing a write processing program (omitted in the drawings) stored on the control device 10.

At step S100 of FIG. 2, the CPU 11 acquires the write data WD. Note that there is no limitation to the acquisition origin of the write data WD and, for example, the CPU 11 may acquire the write data WD from outside of the memory system 1.

Next, at step S102, as described above, the CPU 11 writes the write data WD to the first region 20 of the non-volatile memory 12. Accordingly, this results in a state in which the first write data WD_1 is stored in the first region 20 of the non-volatile memory 12.

Next, at step S104, as described above, the CPU 11 writes the first write data WD_1 to the second region 22 of the OTP 14. This accordingly results in a state in which the second write data WD_2 is stored in the second region 22 of the OTP 14.

Next, at step S106, as described above, the CPU 11 writes the second write data WD_2 to the third region 23 of the non-volatile memory 12. This accordingly results in a state in which the third write data WD_3 is stored in the third region 23 of the non-volatile memory 12. When the processing of step S106 is finished, the write processing illustrated in FIG. 2 is ended.

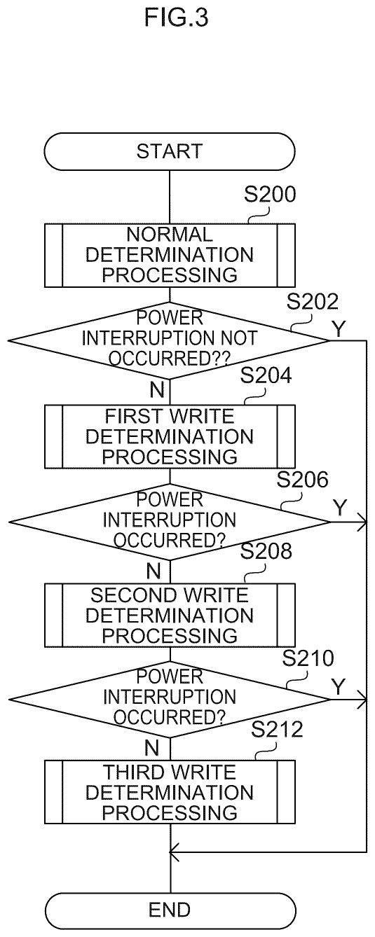

Next, with reference to FIG. 3, description follows regarding detection processing, this being processing performed to detect whether or not a power interruption occurred and to repair the write data as necessary. FIG. 3 is a flowchart illustrating an example of a flow of detection processing executed in the CPU 11. In the present exemplary embodiment, the detection processing illustrated in FIG. 3 is executed by the CPU 11 executing a detection processing program (omitted in the drawings) stored in the control device 10. The detection processing illustrated in FIG. 3 is, for example, executed when power is switched ON for the control device 10.

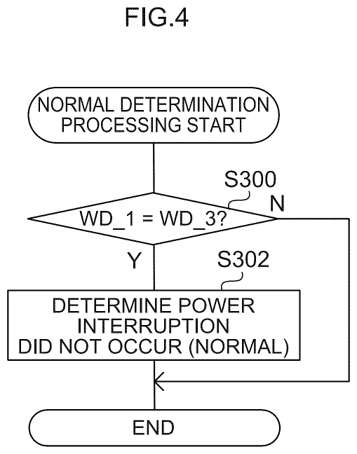

At step S200 of FIG. 3, the CPU 11 executes the normal determination processing illustrated in FIG. 4 and described in detail later. The normal determination processing is processing to determine whether power interruption did not occur ever and the write data is in a normally stored state in all the regions of the first region 20, the second region 22, and the third region 23, or not.

Next, at step S202, the CPU 11 determines whether power had not been interrupted.

In a case in which power had not been interrupted, the determination of step S202 becomes affirmative, and the detection processing illustrated in FIG. 3 is ended. However, in a case in which power had been interrupted, the determination of step S202 becomes negative, and processing proceeds to step S204.

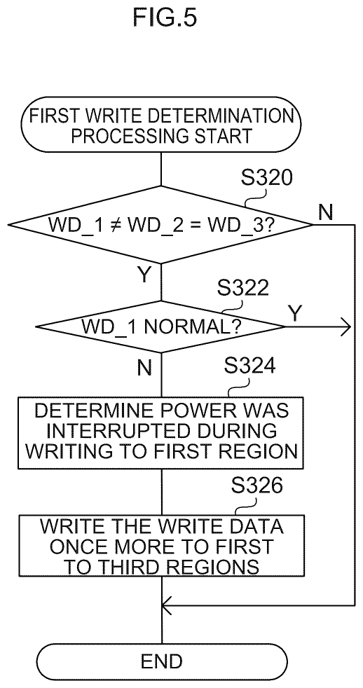

At step S204, the CPU 11 executes the first write determination processing illustrated in FIG. 5, and described in detail later. The first write determination processing is processing to determine whether or not power was interrupted during writing the write data WD to the first region 20 of the non-volatile memory 12 as the first write data WD_1, and to perform repair of the write data stored as necessary.

Next, at step S206, the CPU 11 determines whether or not power had been interrupted during writing the write data WD to the first region 20 of the non-volatile memory 12 as the first write data WD_1. In a case in which determination was that power had been interrupted, the determination of step S206 becomes affirmative, and the detection processing illustrated in FIG. 3 is ended. However, in a case in which power was not interrupted, the determination of step S206 becomes negative, and processing proceeds to step S208.

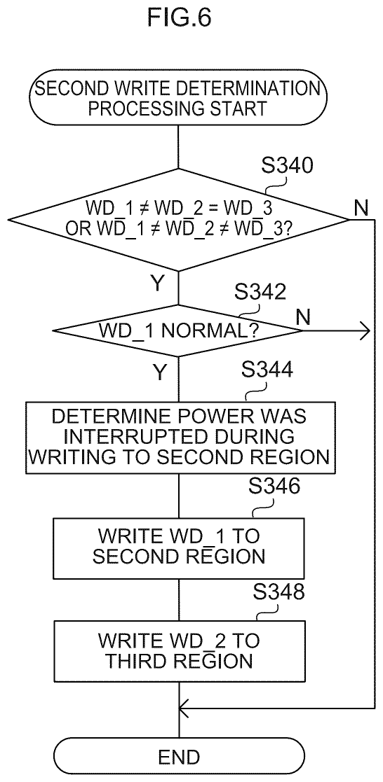

At step S208, the CPU 11 executes the second write determination processing illustrated in FIG. 6 and described in detail later. The second write determination processing is processing to determine whether or not power was interrupted during writing the first write data WD_1 to the second region 22 of the OTP 14 as the second write data WD_2, and to perform repair of the stored write data as necessary.

Next, at step S210, the CPU 11 determines whether or not a power interruption occurred during writing of the first write data WD_1 to the second region 22 of the OTP 14 as the second write data WD_2. In a case in which the power was interrupted, the determination of step S210 becomes affirmative, and the detection processing illustrated in FIG. 3 is ended. However, in a case in which power was not interrupted, the determination of step S210 becomes negative, and processing proceeds to step S212.

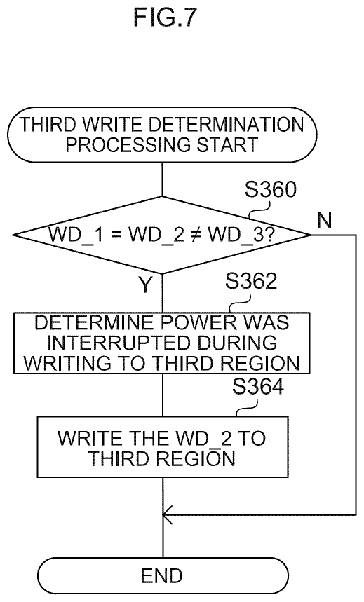

At step S212, the CPU 11 executes the third write determination processing illustrated in FIG. 7 and described in detail later. The third write determination processing is processing to determine whether or not power was interrupted during writing the second write data WD_2 to the third region 23 of the non-volatile memory 12 as the third write data WD_3, and to perform repair of the stored write data as necessary. When the processing of step S212 is finished, the detection processing illustrated in FIG. 3 is ended.

Next, description follows regarding the above normal determination processing, with reference to FIG. 4. At step S300 of the normal determination processing of FIG. 4, the CPU 11 determines whether or not the first write data WD_1 is the same as the third write data WD_3. In a case in which the first write data WD_1 and the third write data WD_3 are not the same, the determination of step S300 becomes negative, the normal determination processing illustrated in FIG. 4 ends, and processing proceeds to step S202 of the above detection processing (see FIG. 3). However, in a case in which the first write data WD_1 and the third write data WD_3 are the same, the determination of step S300 becomes affirmative, and processing proceeds to step S302.

At step S302, the CPU 11 determines that power was not interrupted during writing the write data to any region out of the first region 20, the second region 22, and the third region 23. In other words, the CPU 11 determines that write data has been written normally to all of the regions of the first region 20, the second region 22, and the third region 23. When the processing of step S302 is finished, the normal determination processing illustrated in FIG. 4 is ended, and processing proceeds to step S202 (see FIG. 3) of the above detection processing.

Next, description follows regarding the above first write determination processing, with reference to FIG. 5. At step S320 of the first write determination processing of FIG. 5, the CPU 11 determines whether or not the second write data WD_2 differs from the first write data WD_1 but is the same as the third write data WD_3. In a case in which the second write data WD_2 differs from the first write data WD_1 but is the same as the third write data WD_3, the determination of step S320 becomes affirmative, processing proceeds to step S322. However when the determination of step S320 is negative, the first write determination processing illustrated in FIG. 5 is ended, and processing proceeds to step S206 (see FIG. 3) of the above detection processing.

At step S322, the CPU 11 determines whether or not the first write data WD_1 is normal. Specifically, the CPU 11 uses a check sum attached to the first write data WD_1 to determine whether or not the first write data WD_1 is normal. In a case in which the first write data WD_1 is normal, the determination of step S320 becomes affirmative, the first write determination processing illustrated in FIG. 5 is ended, and processing proceeds to step S206 (see FIG. 3) of the above detection processing. However, processing proceeds to step S324 when the determination of step S322 is negative.

At step S324, the CPU 11 determines that power was interrupted during writing the write data WD to the first region 20 of the non-volatile memory 12 as the first write data WD_1.

Next, at step S326, the CPU 11 once more writes the write data to all of the first region 20, the second region 22, and the third region 23. Namely, the CPU 11 once more executes the write processing illustrated in FIG. 2, and repairs each of the write data stored in the first region 20, the second region 22, and the third region 23. When the processing of step S326 is finished, the first write determination processing illustrated in FIG. 5 is ended, and processing proceeds to step S206 (see FIG. 3) of the above detection processing.

Next, the above second write determination processing will be described with reference to FIG. 6.

At step S340 of the second write determination processing of FIG. 6, the CPU 11 determines whether or not the second write data WD_2 differs from the first write data WD_1 but is the same as the third write data WD_3, or determines whether or not the first write data WD_1, the second write data WD_2, and the third write data WD_3 are all different. In a case in which the second write data WD_2 differs from the first write data WD_1 but is the same as the third write data WD_3, or in a case in which the first write data WD_1, the second write data WD_2, and the third write data WD_3 are all different, the CPU 11 makes an affirmative determination for the determination at step S340, processing proceeds to step S342. However, when the determination of step S340 is negative, ends the second write determination processing illustrated in FIG. 6, and proceeds to step S210 (see FIG. 3) of the above detection processing.

At step S342, the CPU 11 determines whether or not the first write data WD_1 is normal. Specifically, the CPU 11 employs the check sum attached to the first write data WD_1 to determine whether or not the first write data WD_1 is normal. In a case in which the first write data WD_1 is not normal, the determination of step S340 becomes negative, the second write determination processing illustrated in FIG. 6 is ended, and processing proceeds to step S210 (see FIG. 3) of the above detection processing. However, processing proceeds to step S344 when the determination of step S342 becomes affirmative.

At step S344, the CPU 11 determines that the power was interrupted during writing the first write data WD_1 to the second region 22 of the OTP 14 as the second write data WD_2.

Next, at step S346, the CPU 11 repairs the second write data WD_2 stored in the second region 22 by writing the first write data WD_1 to the second region 22 of the OTP 14.

Next, at step S348, the CPU 11 repairs the third write data WD_3 stored in the third region 23 by writing the second write data WD_2 to the third region 23 of the non-volatile memory 12. When the processing of step S348 finishes, the second write determination processing illustrated in FIG. 6 is ended, and processing proceeds to step S210 (see FIG. 3) of the above detection processing.

Furthermore, description follows regarding the above third write determination processing, with reference to FIG. 7.

At step S360 of the third write determination processing of FIG. 7, the CPU 11 determines whether or not the first write data WD_1 is the same as the second write data WD_2 but differs from the third write data WD_3. In a case in which the first write data WD_1 is the same as the second write data WD_2 but differs from the third write data WD_3, the determination of step S360 becomes affirmative, processing proceeds to step S362. However, when the determination of step S360 is negative, the third write determination processing illustrated in FIG. 7 is ended. In such cases the above detection processing is also ended.

At step S362, the CPU 11 determines that power was interrupted during writing the second write data WD_2 to the third region 23 of the non-volatile memory 12 as the third write data WD_3.

Next, at step S364, the CPU 11 repairs the third write data WD_3 stored in the third region 23 by writing the second write data WD_2 to the third region 23 of the non-volatile memory 12. When the processing of step S364 has finished, the third write determination processing illustrated in FIG. 7 is ended. In such cases the above detection processing is also ended.

As described above, the CPU 11 of the control device 10 of the above exemplary embodiment acquires the write data WD, and stores the write data WD in the first region 20 of the non-volatile memory 12 as the first write data WD_1 with a check sum attached thereto. Moreover, the CPU 11 stores the first write data WD_1 as the second write data WD_2 in the second region 22 of the OTP 14. Furthermore, the second write data WD_2 is stored as the third write data WD_3 in the third region 23 of the non-volatile memory 12.

Due to the above configuration, the CPU 11 of the control device 10 of the present exemplary embodiment is able to compare the first write data WD_1 stored in the first region 20, the second write data WD_2 stored in the second region 22, and the third write data WD_3 stored in the third region 23. Accordingly, based on comparison results, the CPU 11 may detect whether power was interrupted during writing the write data to any of the first region 20, the second region 22, or the third region 23, and may repair the stored write data as necessary.

Thus, the control device 10 of the present exemplary embodiment may detect whether or not the power was interrupted during writing of write data to a non-rewritable storage section, and may repair the stored write data.

Sometimes when power was interrupted unintentionally during writing of write data to a non-rewritable storage section then this results in the write data being stored in an abnormal state, such as being stored in an incomplete state, being stored in a faulty state, or the like. In such cases, the control device 10 of the present exemplary embodiment may detect whether or not the power was interrupted during writing of the write data to the non-rewritable storage section as described above, and may repair the stored write data.

Note that in the above exemplary embodiment, the CPU 11 may take information regarding whether or not power was interrupted, or where/when power was interrupted, and whether write data stored in one or other region has been repaired, and store this information inside the control device 10, or output this information externally.

Moreover, although in the present exemplary embodiment the second write data WD_2 is stored attached with the check sum in the third region 23 of the non-volatile memory 12 as the third write data WD_3, a check sum is not necessarily attached to the third write data WD_3. Note that, by attaching the check sum to the third write data WD_3 stored in the third region 23, as in the present exemplary embodiment, the check sum can be employed to determine whether or not data corruption has occurred during transmission of data from outside. Moreover, the check sum can be employed to determine whether or not there is an abnormality in the data caused by faulty writing during writing of data, overwriting data for some reason or other, or the like.

Moreover, although in the above exemplary embodiment a mode has been described in which the OTP 14 is employed as an example of a non-rewritable storage section, there is no limitation to this mode. For example, a mode may be adopted in which fuses are employed as the non-rewritable storage section.

The following supplements are also disclosed in relation to the above exemplary embodiments.

### Supplement 1

A control device including:
a processor, the processor being configured to:
acquire write data;
store the write data as first write data in a first region of a non-volatile storage section with an error detection code attached;
store the first write data as second write data in a second region of a non-rewritable storage section; and
store the second write data as third write data in a third region of the non-volatile storage section.

### Supplement 2

The control device of Supplement 1, wherein the processor is configured to determine whether or not power was interrupted during writing, based on a comparison result from comparing the first write data, the second write data, and the third write data.

### Supplement 3

The control device of Supplement 2, the processor is configured to determine that the power was not interrupted during writing, in a case in which the first write data and the third write data are determined to be the same.

### Supplement 4

The control device of Supplement 2 of Supplement 3, wherein the processor is configured to determine that the power was interrupted during writing the first write data to the first region, in a case in which the first write data and the second write data differ, the second write data and the third write data are the same, and the first write data has been determined not to be normal based on the error detection code.

### Supplement 5

The control device of Supplement 4, wherein, in a case in which it is determined that the power was interrupted, the processor is configured to:
acquire the write data; and
store the third write data as the first write data in the first region with an error detection code attached.

### Supplement 6

The control device of any one of Supplement 2 to Supplement 5, the processor is configured to determine that the power was interrupted during writing the second write data to the second region, either:
in a case in which the first write data and the second write data differ, the second write data and the third write data are the same, and the first write data has been determined to be normal based on the error detection code, or
in a case in which the first write data, the second write data, and the third write data are all different, and also the first write data has been determined to be normal based on the error detection code.

### Supplement 7

The control device of Supplement 6, wherein, in a case in which it is determined that the power was interrupted, the processor is configured to:
store the first write data in the second region as the second write data; and
store the second write data in the third region as the third write data.

### Supplement 8

The control device of any one of Supplement 2 to Supplement 7, wherein the processor is configured to determine that the power was interrupted during writing the third write data to the third region, in a case in which the first write data and the second write data are the same, and the first write data and the third write data are different.

### Supplement 9

The control device according to Supplement 8, wherein, in a case in which it is determined that the power was interrupted, the processor is configured to store the second write data as the third write data in the third region.

### Supplement 10

A detection method for detecting whether or not power was interrupted during processing by a processor of a control device during storing of write data in a non-rewritable storage section, the detection method including:
acquiring write data;
storing the write data as first write data in a first region of a non-volatile storage section with an error detection code attached;
storing the first write data as second write data in a second region of a non-rewritable storage section;
storing the second write data as third write data in a third region of the non-volatile storage section; and
determining whether or not the power was interrupted during writing, based on a comparison result from comparing the first write data, the second write data, and the third write data.

### Supplement 11

A non-transitory computer-readable medium storing a detection program executable by a processor of a control device to perform processing to detect whether or not power was interrupted during processing to store write data in a non-rewritable storage section, the processing including:
acquiring write data;
storing the write data as first write data in a first region of a non-volatile storage section with an error detection code attached;
storing the first write data as second write data in a second region of a non-rewritable storage section;
storing the second write data as third write data in a third region of the non-volatile storage section; and
determining whether or not power was interrupted during writing, based on a comparison result from comparing the first write data, the second write data, and the third write data.

What is claimed is:

1. A control device comprising:
a processor, the processor being configured to:
acquire write data;
store the write data as first write data in a first region of a non-volatile storage section with an error detection code attached;
store the first write data as second write data in a second region of a non-rewritable storage section; and
store the second write data as third write data in a third region of the non-volatile storage section.

2. The control device according to claim 1, wherein the processor is configured to determine whether or not power was interrupted during writing, based on a comparison result from comparing the first write data, the second write data, and the third write data.

3. The control device according to claim 2, wherein the processor is configured to determine that the power was not interrupted during writing, in a case in which the first write data and the third write data are determined to be the same.

4. The control device according to claim 2, wherein the processor is configured to determine that the power was interrupted during writing the first write data to the first region, in a case in which the first write data and the second write data differ, the second write data and the third write data are the same, and the first write data has been determined not to be normal based on the error detection code.

5. The control device according to claim 4, wherein, in a case in which it is determined that the power was interrupted, the processor is configured to:
acquire the write data; and
store the third write data as the first write data in the first region with an error detection code attached.

6. The control device according to claim 2, wherein the processor is configured to determine that the power was interrupted during writing the second write data to the second region, either:
in a case in which the first write data and the second write data differ, the second write data and the third write data are the same, and the first write data has been determined to be normal based on the error detection code, or
in a case in which the first write data, the second write data, and the third write data are all different, and also the first write data has been determined to be normal based on the error detection code.

7. The control device according to claim 6, wherein, in a case in which it is determined that the power was interrupted, the processor is configured to:
store the first write data in the second region as the second write data; and
store the second write data in the third region as the third write data.

8. The control device according to claim 2, wherein the processor is configured to determine that the power was interrupted during writing the third write data to the third region, in a case in which the first write data and the second write data are the same, and the first write data and the third write data are different.

9. The control device according to claim 8, wherein, in a case in which it is determined that the power was interrupted, the processor is configured to store the second write data as the third write data in the third region.

10. A detection method for detecting whether or not power was interrupted during processing by a processor of a control device during storing of write data in a non-rewritable storage section, the detection method comprising:
acquiring write data;
storing the write data as first write data in a first region of a non-volatile storage section with an error detection code attached;
storing the first write data as second write data in a second region of a non-rewritable storage section;
storing the second write data as third write data in a third region of the non-volatile storage section; and
determining whether or not the power was interrupted during writing, based on a comparison result from comparing the first write data, the second write data, and the third write data.

11. A non-transitory computer-readable medium storing a detection program executable by a processor of a control device to perform processing to detect whether or not power was interrupted during processing to store write data in a non-rewritable storage section, the processing comprising:
acquiring write data;
storing the write data as first write data in a first region of a non-volatile storage section with an error detection code attached;
storing the first write data as second write data in a second region of a non-rewritable storage section;
storing the second write data as third write data in a third region of the non-volatile storage section; and
determining whether or not power was interrupted during writing, based on a comparison result from comparing the first write data, the second write data, and the third write data.
